(19) United States
(12) Patent Application Publication
(10) Pub. No.: US 2009/0196690 A1
(43) Pub. Date: Aug. 6, 2009

(54) ANTI-SLIP COMPOSITION AND METHOD OF FORMING ANTI-SLIP LAYER USING THE SAME

(76) Inventors: Kyung-Ho Kim, Jeju-si (KR); Yong-Gyun Kim, Jeju-si (KR)

Correspondence Address: IPLA P.A., 3580 WILSHIRE BLVD., 17TH FLOOR, LOS ANGELES, CA, 90010, US

(21) Appl. No.: 12/304,221

(22) PCT Filed: Oct. 10, 2007
(86) PCT No.: PCT/KR2007/004937

§ 371 Date: Dec. 10, 2008

(30) Foreign Application Priority Data
Dec. 22, 2006 (KR) 10-2006-0132462

(51) Int. Cl. E01C 23/14; C08J 5/14

(52) U.S. Cl. 404/79; 523/150

(57) ABSTRACT

A non-slip composition used for paving a road and a method of forming a skid resistant pavement using the non-slip composition. The non-slip composition includes a mixture of a tire waste, a steel slag and a ceramic waste as a main component, and is constructed as a skid resistant pavement on a specific section of the road, such as a sharp slope, a sharp curve or a ramp, which requires a braking distance, in order to prevent vehicles from skidding on the road.

### TECHNICAL FIELD

The present invention relates to a non-slip composition used for paving a road and a method of forming a skid resistant pavement using the non-slip composition, and more particularly, to a non-slip composition, which includes a mixture of a tire waste, a steel slag and a ceramic waste as a main component, and is constructed as a skid resistant pavement on a specific section of the road, such as a sharp slope, a sharp curve or a ramp, which requires a braking distance, in order to prevent vehicles from skidding on the road.

### BACKGROUND ART

In general, as more vehicles are used due to the development of industries, more roads are getting constructed in order to improve traffic conditions and more traffic safety facilities are getting built in order to prevent accidents. Existing road pavements generally include an asphalt pavement composed of a roadbed acting as a basis and an asphalt surface layer having a thickness of at least 10 to 15 cm, and a cement concrete pavement composed of a roadbed and a concrete plate.

In a specific section of the asphalt or concrete road, which requires a braking distance, such as a sharp slope, since a sharp curve or a ramp, snow or rain frequently causes a slip or skid, a risk of car accident exists.

Currently, a skid resistant pavement is constructed on a the surface of a road or a bridge, and a strip of the skid resistant pavement has a width of about 1 to 6 m, and optionally a larger width according to road conditions. The strip of the skid resistant pavement is also spaced apart from an adjacent strip at an interval of 1 to 6 m. A non-slip composition currently used in the construction of the skid resistant pavement is produced by mixing a steel slag or glass beads with an epoxy resin binder. The skid resistant pavement is constructed with a thickness of about 3.5 to 5 mm, using a steel slag or glass beads, which are particles having a size of about 3 to 5 mm.

When a vehicle runs at a high speed on the skid resistant pavement, which is constructed across the road with a thickness of about 3.5 to 5 mm, a friction occurs between the skid resistant pavement and wheels of the vehicle due to the load of the vehicle that the wheels support, thereby causing a severe fatigue to the surface of the road, so that the asphalt in the road surface cannot stand for a long time. That is, minute cracks are formed and the road surface is partially damaged, thereby shortening the lifetime of the road surface, which causes great economic burden.

In addition, the skid resistant pavement shakes the vehicle, which runs thereon, thereby wearing the wheels. Transport vehicles shake more severely and thus have another problem in addition to the wear of the wheels. That is, the severe shaking of the transport vehicles frequently damages freight (e.g., eggs, fruits and electronics) loaded on the transport vehicles, thereby causing economic loss, followed by the enmity of the people. Accordingly, the construction of the skid resistant pavement decreases and is selectively performed on specific areas where car accidents are frequent.

Furthermore, a steel slag applied on the surface of the road is oxidized by the air or the moisture on the surface of the road, thereby creating rust, which causes incidental problems such as stains on the surface of the road and water contamination. A glass waste is easily crushed due to its fragility and scatters to a nearby pedestrian pavement (e.g., a sidewalk or footpath), possibly injuring pedestrians. Glass beads are scattered to areas around the road by the wind or high speed vehicles, thereby contaminating the surrounding areas.

In a specific area such as a school zone, an epoxy paint is applied on the skid resistant pavement in order to color the pavement yellow or red. However, the epoxy paint may cause skid. Byproducts scattered by the friction against vehicle wheels are economically unfriendly and harmful to the human, in particular, to infants or children. Especially, a child falling down on the road of this area may be pierced and hurt by a glass waste or the like.

Conventional skid resistant constructions generally include three types. The first type of skid resistant construction is manufactured by applying a resin on the road, sprinkling a slag on the resin, and pounding the resultant layer with a roller in order to finish the construction. However, this type of construction is rarely flexible and easily separated from the asphalt bed when used for a long time. The resin needs a long time to cure, such as 3 to 4 hours, so that the entire construction time becomes 5 hours or more. Furthermore, this type of skid resistant construction causes a severe shaking to a vehicle running thereon, and thus causes a poor driving comfort to a driver and/or a passenger. The shaking also accelerates the aging of the vehicle. The second type of skid resistant construction is manufactured by resin application, glass waste scattering and finish-curing. However, this type of skid resistant construction has poor abrasion resistance, and when used for a long time, glass waste particles are peeled off from resin-containing protrusions of the surface, thereby deteriorating non-slip performance.

Accordingly, Korean Utility Model Registration No. 0145808 discloses a skid resistant pavement on an asphalt deck or a concrete deck of a bridge. In the skid resistant pavement, a non-slip material of aluminum oxide grit (emery) particles having a particle size of 35 to 50 meshes (0.5 mm to 0.7 mm) is adhered to the deck surface by a binder to enhance durability. In this non-slip material, however, aluminum oxide grits (emery) contain CaO (F—CaO) of 0.1 to 20 percent by weight, in which unreacted F—CaO reacts with water (H₂O) to generate an alkali compound Ca(OH)₂, which in turn contaminates water and air as well as leads to chemical weathering, thereby reducing the lifetime of the road.

Recently, several factors, such as climate changes caused by the global warming and indiscreet burying of waste materials, lead to seawater acidification, which in turn decays and reduces microorganisms. As a result, the earth is suffering from waste such as waste materials. Accordingly, various researches are undergoing in order to recycle waste materials for various uses. In this consideration, the inventor has developed a non-slip composition, which is environment friendly, can promote traffic conditions and traffic safety and lead to an economical effect due to recycling, and has an excellent braking effect, by manufacturing the non-slip composition using waste materials, which are produced by a large amount from daily lives and do not rot even if buried.

### DISCLOSURE OF INVENTION

### Technical Problem

The present invention has been made to solve the foregoing problems with the prior art, and therefore an aspect of the present invention is to provide a non-slip composition, which is manufactured by mixing a ceramic waste and a tire waste, each of which has a predetermined particle size, with a steel slag having a predetermined particle size. The non-slip composition is environment friendly, provides an economical effect due to the recycling of resources, and is paved on a specific section of the road, which requires a braking distance, such as a sharp slope, a sharp curve or a ramp, in order to prevent vehicles from skidding on the road.

Another aspect of the present invention is to manufacture the non-slip composition having a predetermined particle size, which can enhance binding force between the non-slip composition and a resin binder composition, thereby reducing non-slip composition particles wearing from a pavement, and which can be constructed rapidly in order to remarkably shorten a period where the traffic is jammed or blocked.

### Advantageous Effects

According to the present invention as set forth above, a main material includes a ceramic waste and a tire waste, both of which have excellent skid resistance, and a resin binder composition includes a mixture of a thermoplastic resin and a thermosetting resin. The non-slip composition or the skid resistant pavement can be securely bound to the road for a long time without being separated or detached therefrom, and have excellent physical properties such as abrasion resistance, impact resistance and thermal impact resistance, which can prevent the skid resistant pavement from being broken or damaged by continuous impact and/or abrasion due to the traffic of vehicles, thereby remarkably increasing the lifetime of the pavement. By using a roller in the process of paving the non-slip composition, protrusions of a predetermined coarseness (roughness) can be formed on the surface of the anti-skid pavement in order to further enhance skid resistance, thereby improving stability and reliability.

### BRIEF DESCRIPTION OF THE DRAWINGS

FIG. 1 is a view illustrating a road, on which a non-slip composition of the present invention is applied.

### MAJOR REFERENCE SIGNS OF THE DRAWINGS

10: road
11: surface layer
12: skid resistant pavement
13: resin composition
14: non-slip composition

### BEST MODE FOR CARRYING OUT THE INVENTION

According to an aspect of the present invention, there is provided a non-slip composition, which includes a tire waste; and a reducing agent of 10 to 90 percent by weight. The reducing agent has a particle size ranging from 0.1 to 5 mm, and includes a ceramic waste, a steel slag and a mixture thereof.

In the non-slip composition of the present invention, the tire waste may have a particle size ranging from 3 to 4 mm, and comprise 10 to 90 weight percent.

According to another aspect of the present invention, there is provided a method of forming a skid resistant pavement on the surface layer of the road using a non-slip composition. The method includes procedures of: preparing the non-slip composition by mixing a reducing agent of 10 to 90 percent by weight, which has a particle size ranging from 0.1 to 5 mm, and a tire waste of 10 to 90 percent by weight, which has a particle size ranging from 3 to 4 mm; preparing a resin binder composition by mixing a resin composition, which comprises at least one selected from the group consisting of epoxies, acrylates and urethanes, and a pine resin; heating and mixing the non-slip composition and the resin binder composition in a mixer, thereby preparing a road-paving material; and applying the road-paving material on the surface layer of the road, applying glass waste powder or glass beads on the road-paving material applied on the surface of the road, planerizing a resultant layer with a roller, and spraying water to the resultant layer to cure.

### MODE FOR THE INVENTION

Hereinafter the present invention will be described more fully with reference to the accompanying drawing, in which exemplary embodiments thereof are shown.

The non-slip composition for road pavement of the present invention includes a ceramic waste, a tire waste and a steel slag, each of which is mixed at a predetermined content.

The non-slip composition of the present invention is applied on the surface layer of an asphalt road or a concrete road, and includes a reducing agent of 10 to 90 percent by weight, which has a particle size of 0.1 mm to 5 mm. The reducing agent is composed of a ceramic waste, a steel slag, or a mixture thereof.

The ceramic waste should be construed as having a wide concept, which embraces various types of ceramic wares, such as interior/exterior ceramic tiles, which are widely used in daily lives, dishes and insulators; a large amount of waste ceramics, which are produced in a process of manufacturing porcelain products; and waste clamshells.

The particle size of the ceramic waste and the steel slag is in the range from 0.1 mm to 5 mm because, if the particle size is in this range, the ceramic waste can satisfy both skid resistance due to unevenness and nighttime visibility. Specifically, the particle size below 0.1 mm is too small to enhance skid resistance, but the particle size exceeding 5 mm causes a poor driving comfort to a vehicle running on the skid resistant pavement while lowering the binding force between the skid resistant pavement and a resin binder composition, so that the skid resistant pavement can be peeled off or detached from the road. It is most preferable that the ceramic waste and the steel slag be crushed into a particle size ranging from 3 to 4 mm.

Preferably, the content of the ceramic waste or the steel slag is in the range from 10 to 90% by weight. The content below 10% by weight degrades the durability of the skid resistant pavement, but the content above 90% by weight results in poor binding force.

In addition, a suitable amount of tire waste made of rubber can be mixed into the non-slip composition in order to impart a shock absorbing property to the skid resistant pavement, which includes the non-slip composition paved on the surface of the road, or raise the ability of binding the skid resistant pavement to the surface of the road.

The tire waste of 10 to 90 percent by weight may be mixed with the reducing agent, which is produced by mixing the ceramic waste and/or the steel slag, each of which has a particle size of 0.1 to 5 mm. More preferably, the particle size of the tire waste can be set 3 to 4 mm in order to enhance the shock absorbing ability of the skid resistance pavement and the binding force between the skid resistance pavement and the surface of the road.

The mixed tire waste can generate frictional heat through rubbing against tires of running vehicles. This is advantageous especially in the winter since the frictional heat can rapidly melt the frozen surface of the road.

Hereinafter a method of paving a mixture of a non-slip composition and a liquid resin binder composition on the surface of the road will be described in detail.

A ceramic waste and a steel slag, each of which has a particle size of 0.1 to 5 mm, are uniformly mixed to produce a non-slip composition. The non-slip composition of 80 percent by weight and a resin composition of 20 percent by weight, which is mixed with pigments of various colors, are heated and mixed in a mixer to produce a road-paving material. Then, the resultant road-paving material is applied on the surface of the road.

Then, glass beads of glass waste powder or fine glass dust, which has a particle size capable of passing through a 106□ mesh, are scattered by the amount of 0.29 to 1.4 kg per 1 m₂ on the road-paving material which is applied on the surface of the road. The resultant layer is pounded and planarized with a roller, and then cured, thereby producing a skid resistant pavement.

The glass beads of glass waste powder or fine glass dust can reduce the drying time of the road-paving material paved on the surface of the road. The glass beads also have a retro-reflecting function of reflecting back headlight beams, and thus, at a sharp curve or a sharp downhill, can act as warning signs for drivers.

The resin binder composition includes at least one selected from the group consisting of epoxies, acrylates and urethanes. The resin binder composition can be implemented with at least one selected from the group consisting of epoxies, acrylates and urethanes, into which a pine resin is added. The added pine resin can increase the thermal resistance of the skid resistant pavement applied on the road in order to more or less alleviate the surface of the road from softening during hot summer.

The road means a typical paved road made of asphalt. The concept of the slag embraces stainless slags and steel slags, which are by-produced during smelting for processing metal or impurities in ores in the steel making process, welding, other metal processes and combustion.

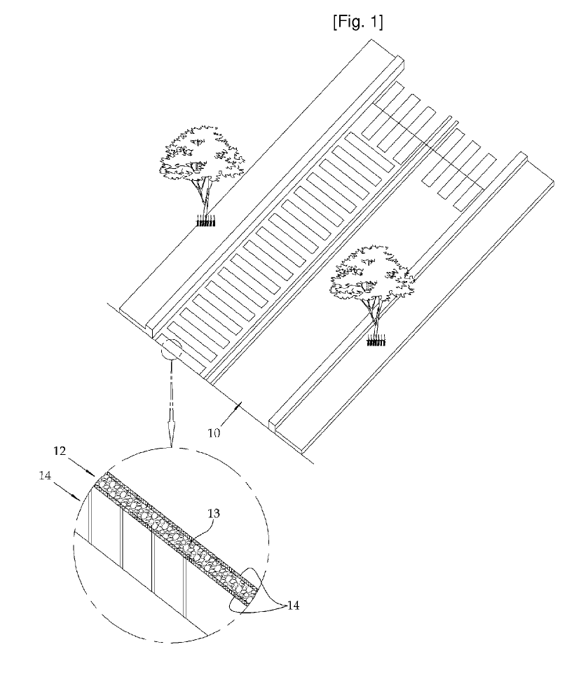

FIG. 1 is a view illustrating a road 10, on which a non-slip composition 14 of the present invention is applied. Like the prior art, the road 10 includes a roadbed (not shown) acting as a bed of the road and a surface layer 11 made of asphalt or concrete. The present invention provides the skid resistant pavement 12, which is laterally or longitudinally formed on the surface layer of the road 10. That is, the skid resistant pavement 12 is added to and covered on the surface layer 11 of the road 10. The skid resistant pavement 12 is made of a road-paving material, which is obtained by mixing the non-slip composition 14 and a resin binder composition 14, and is applied and bound to the surface layer of the road.

As mentioned above, the non-slip composition 13 includes a ceramic waste of 10 to 90 percent by weight, which has a particle size of 0.1 mm to 5 mm, and a steel slag of 10 to 90 percent by weight, which has a particle size of 0.1 to 5 mm. The resin binder composition 13 may be selectively embodied with a binding agent selected from epoxies, acrylates and urethanes in order to enhance binding force. The resin binder composition 13 acts to bind the particles of the non-slip composition 14 to each other while binding the skid resistant pavement 12 to the surface layer 11 of the road 10.

The skid resistant pavement 12 as shown in FIG. 1 is constructed on the surface layer 11 of the road 10 as follows: A lane, for example, an outer lane, on which the skid resistant pavement 12 will be constructed, is clearly cleaned, and tapes (not shown) are attached to opposite longitudinal edges of the lane in order to prevent the binding resin composite 13 from flowing to an adjacent lane.

Next, the road-paving material, that is, the mixture of the non-slip composition 14 and the resin binder composition 13 is applied to a thickness of about 10 mm on the surface layer 11 of the road 10, and the resin binder composition 13 is fully dried before the tapes are detached from the surface of the road. Then, the construction is completed by removing part of the non-slip composition 14, which is not in contact with the resin binder composition 13, from the surface layer of the road. In particular, waste materials, such as tapes, vinyl pieces and other byproducts produced during the construction, are charged into a mixer, by which the waste materials are mixed together with the non-slip composition and the resin binder composition. This provides a merit of recycling the waste materials produced during the construction. The skid resistant pavement 12 of the present invention can be variously constructed along the width or length direction of the road.

Various materials, such as liming white, stone powder, sand, a binder mixed with waste tile, produced at the removal of a building or a construction, and a mortar, are crushed into a particle size of 3 mm to 4 mm, charged into a container, and mixed together with a liquid epoxy resin, a drying accelerant and a dye. At a construction site, the resultant material is applied on an asphalt concrete-paved surface or a concrete-paved surface, and is finish-treated, followed by a final procedure of spraying water on the paved surface to cure the resultant material. Accordingly, right after the construction, the road can be opened for traffic in order to prevent a traffic jam.

Hereinafter the present invention will be described in more detail with reference to following Examples. It should be understood, however, the present invention is not limited to the following Examples.

### Example 1

A non-slip composition was prepared by mixing a ceramic waste of 40 percent by weight having an average particle size of about 2.4 mm, a tire waste of 40 percent by weight having an average particle size of about 2.4 mm and a steel slag of 20 percent by weight having an average particle size of about 1 mm, and was applied on the surface layer of the road using an epoxy resin binder according to the following dimensions: 1 m width, 2 m interval and approximately 3 mm thickness.

### Comparative Example 1

A steel slag or a conventional non-slip material for roads was applied on the surface layer of the road using an epoxy resin binder according to the following dimensions: 1 m width, 2 m interval and approximately 3 mm thickness.

Table 1 below compares the skid resistance and the binding strength of Example 1, in which a road-paving material using the non-slip composition of the present invention was constructed, with those of Comparative Example 1, in which a road-paving material using the conventional non-slip composition was constructed.

TABLE 1

| | Slip resistance (BPN) | Binding strength (N/mm²) |
|---|---|---|
| Example 1 | 78 | 1.61 |
| Comp. Example 1 | 63 | 1.21 |

As seen from Table 1 above, the skid resistance and the binding strength of the non-slip composition used Example 1 are superior to those of Comparative Example 1.

The durability of the road, on which the paving material of Example 1 was constructed, was measured using various vehicles. In the measurement, it was observed that the non-slip composition had excellent binding force and wore less than the conventional non-slip composition. The non-slip composition also had excellent frictional force against wheels of the vehicles, thereby achieving excellent non-slip effect. Furthermore, the non-slip composition was able to reduce the slip of the vehicles even in the rain or snow, and did not produce an alkali compound Ca(OH)₂.

In the construction performed according to the present invention, the road-paving material having a non-slip function is applied on the road, and then glass beads of glass waste powder or fine glass dust are scattered on the surface of the road-paving material before it cures in order to improve a retro-reflecting function.

That is, after the road-paving material partially including glass beads of glass waste powder or fine glass dust is applied on the surface of the road, glass beads of glass waste powder or fine glass dust are additionally scattered on the surface in a procedure of forming protrusions on the surface using a roller. When the resultant layer is cured for 20 to 30 minutes at room temperature, the glass beads of glass waste powder or fine glass dust are uniformly bound to the surface and inside of the paving material.

When headlight beams from a vehicle are projected to the road-paving material to which the glass beads of glass waste powder or fine glass dust are bound, the protrusions on the surface of the road-paving material reflect back the beams to call driver's attention, which is not enabled by conventional planar products. Accordingly, the road-paving material of the present invention can also be effectively used in various areas such as a bus only lane, a school zone, a green zone and a yellow zone.

The reflecting materials may be implemented with crushed clamshells in place of the glass beads in order to achieve the substantially same effect. Furthermore, in the case of paving the road with an asphalt concrete, rubbles or broken stones can be mixed with the ceramic waste, so that an aesthetic appearance added with the color of the ceramic waste can be obtained. This also makes it possible to select and mix a specific color of ceramic waste according to a desired color of the road without having to use a paint having a specific color. Accordingly, the color of the road can be maintained for a long time period.

1. A non-slip composition, comprising:
a tire waste; and
a reducing agent of 10 to 90 percent by weight, wherein the reducing agent has a particle size ranging from 0.1 to 5 mm, and comprises a ceramic waste, a steel slag and a mixture thereof.

2. The non-slip composition of claim 1, wherein the tire waste has a particle size ranging from 3 to 4 mm, and comprises 10 to 90 percent by weight.

3. A method of forming a skid resistant pavement on a surface layer of a road using a non-slip composition, comprising:
preparing the non-slip composition by mixing a reducing agent of 10 to 90 percent by weight, which has a particle size ranging from 0.1 to 5 mm, and a tire waste of 10 to 90 percent by weight, which has a particle size ranging from 3 to 4 mm;
preparing a resin binder composition by mixing a resin composition, which comprises at least one selected from the group consisting of epoxies, acrylates and urethanes, and a pine resin;
heating and mixing the non-slip composition and the resin binder composition in a mixer, thereby preparing a road-paving material; and
applying the road-paving material on the surface layer of the road, applying waste glass powder or glass beads on the road-paving material applied on the surface of the road, planerizing a resultant layer with a roller, and spraying water to the resultant layer to cure.
